(19) United States
(12) Patent Application Publication
(10) Pub. No.: US 2018/0290370 A1
(43) Pub. Date: Oct. 11, 2018

(54) FILM-DRAWING MACHINE AND METHOD FOR STARTING SAME

(71) Applicant: BRÜCKNER MASCHINENBAU GMBH & CO. KG, Siegsdorf (DE)

(72) Inventor: Gilbert TRIVERO, La Chavanne (FR)

(21) Appl. No.: 15/740,275

(22) PCT Filed: Mar. 31, 2016
(86) PCT No.: PCT/EP2016/057028

§ 371 Date: Dec. 27, 2017

(30) Foreign Application Priority Data
Jun. 30, 2015 (FR) 15/01376

(51) Int. Cl. B29C 55/16; B29C 55/20; B29C 37/00

(52) U.S. Cl. CPC B29C 55/165; B29C 2037/90; B29C 37/00; B29C 55/20

(57) ABSTRACT

The invention relates to a film-drawing machine, including a furnace, through which one strand of an endless chain of clamps passes, driven by at least one toothed wheel, characterised in that at least one toothed wheel is inside the furnace, is rotated by its own gear motor surrounded by a casing, placed in the furnace and cooled by cooling means, and is mounted on its own movement device, so as to pass from a withdrawn position, in which it does not mesh with the chain, to a drive position, in which it meshes with the chain. The invention also relates to a method for starting said film-drawing machine.

The present invention relates to film-drawing or sheet-drawing machines, in particular plastics films, and more particularly to machines of this type which draw a film simultaneously. The invention applies in particular to simultaneous angular drawing. The preheated plastics material is drawn simultaneously in the longitudinal direction and in the transverse direction at a drawing angle in the drawn film that is different from 90°, being for example 45° or 135°. The simultaneous angular drawing can be carried out using a machine comprising two endless tracks that enter and leave a furnace while diverging at said furnace and each comprise a first rail on which clamps move, and a second rail on which articulated carriages move, in a chain pulled by a toothed wheel that is arranged outside the furnace and comprises two consecutive clamps. The hinge of each carriage comprising two consecutive clamps makes it possible to adjust the pitch of the clamps, that is to say their mutual distance along the track (see for example FR 2 922 810 A1 which discloses a film-drawing machine comprising a furnace through which a strand of an endless chain of clamps passes, which chain is driven by at least one toothed wheel).

These machines can be very long in the chain pull direction, having a length of several tens of metres, for example thirty to forty metres. In particular when the film to be drawn is relatively thick, having for example a thickness of approximately 100 microns, the force required by a toothed wheel arranged outside the furnace to pull the chain is too great. The radial forces on the rails are huge. This results in clamp pitch deviation. The inaccuracy of the clamp pitch impairs the regularity of the drawing and thus the optical qualities of the films obtained.

The machine according to the invention overcomes this drawback by making it possible to produce films having a better optical quality, even for thick films.

The film-drawing machine according to the invention, in particular of the above-mentioned type, comprises a furnace, through which a strand of an endless chain of clamps passes, which chain is driven by at least one toothed wheel. Said machine is characterised in that at least one toothed wheel is inside the furnace, is rotated by its own gear motor surrounded by a casing, placed in the furnace and cooled by cooling means, and is mounted on its own movement device, so as to pass from a retracted position, in which it does not mesh with the chain, to a drive position, in which it meshes with the chain.

Since the furnace has a temperature of approximately 200° C., it would not have been believed possible until now to place a toothed wheel therein that was able to function correctly. However, if the toothed wheel is rotated by a gear motor surrounded by a casing, placed in the furnace and cooled by cooling means, the mounting is reliable. The gear motor and its electronic control components are protected by the casing from overheating, which would impair the operation of said components, while the toothed wheel, which is outside the casing but of which the operation is purely mechanical, can withstand these high temperatures.

A plurality of toothed wheels is preferably provided inside the furnace, each preferably comprising at least five teeth. Each wheel comprises its own gear motor, which comprises its own casing.

In order to mechanically bias the clamp as little as possible, it is advantageous to link said clamp in the chain to a carriage having a roller that penetrates into the tooth space of the toothed wheel inside the furnace. In general, carriage rollers have a vertical axis and the clamps close at a point for adjusting the pitch of said clamps outside the furnace.

The movement device is preferably a device for translating in a direction perpendicular to the chain.

In general, the toothed wheels inside the furnace help one or more toothed wheels outside the furnace to pull the chain.

A machine according to the invention usually comprises two mutually diverging chains in the furnace, the clamps of one of the chains moving on first rails and the carriages of the same chain on second rails, this applying to each of the chains.

In order to facilitate the start-up of the machine, each toothed wheel comprises its own detector, which detects the tooth pitch of the wheel, the chain comprises a sensor which is specific to each wheel and detects the clamp pitch at the point where the toothed wheel meshes therewith, and a central control unit of the machine is connected to the sensor and to the detector and, when the pitches match, controls the movement device in order to place the wheel into the drive position. The breakage of mechanical components, which would cause desynchronisation, is thus prevented.

The control is all the more reliable in that the power supply wires for the gear motor leave the casing through the inlet, in the casing, for the cooling air from the cooling means and in that, in the inlet, the wires are surrounded by a shared sleeve, which is itself surrounded at a distance by a thermally insulating sheath.

The invention also relates to a method for starting a film-drawing machine, characterised in that, while the wheels are retracted, the matching of the tooth pitch of each wheel with the clamp pitch at the point where each wheel is intended to mesh with the chain is monitored and, if there is matching, the speed of rotation of the wheels is synchronised at low speed with the movement speed of the chain, then the wheels are placed in the drive position and all speeds are increased synchronously.

In the accompanying drawings, given only by way of example:

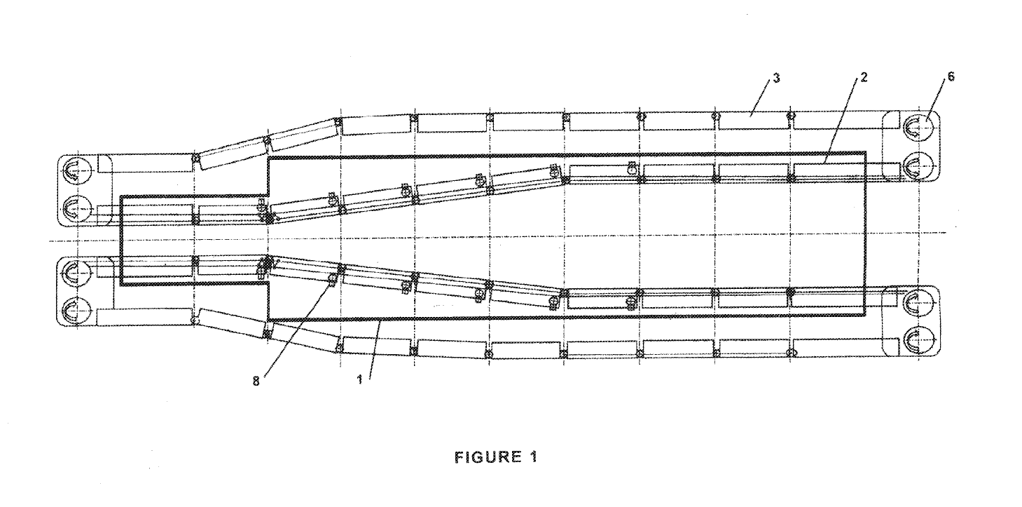

FIG. 1 is a schematic plan view of a machine according to the invention, the top of the furnace having been removed;

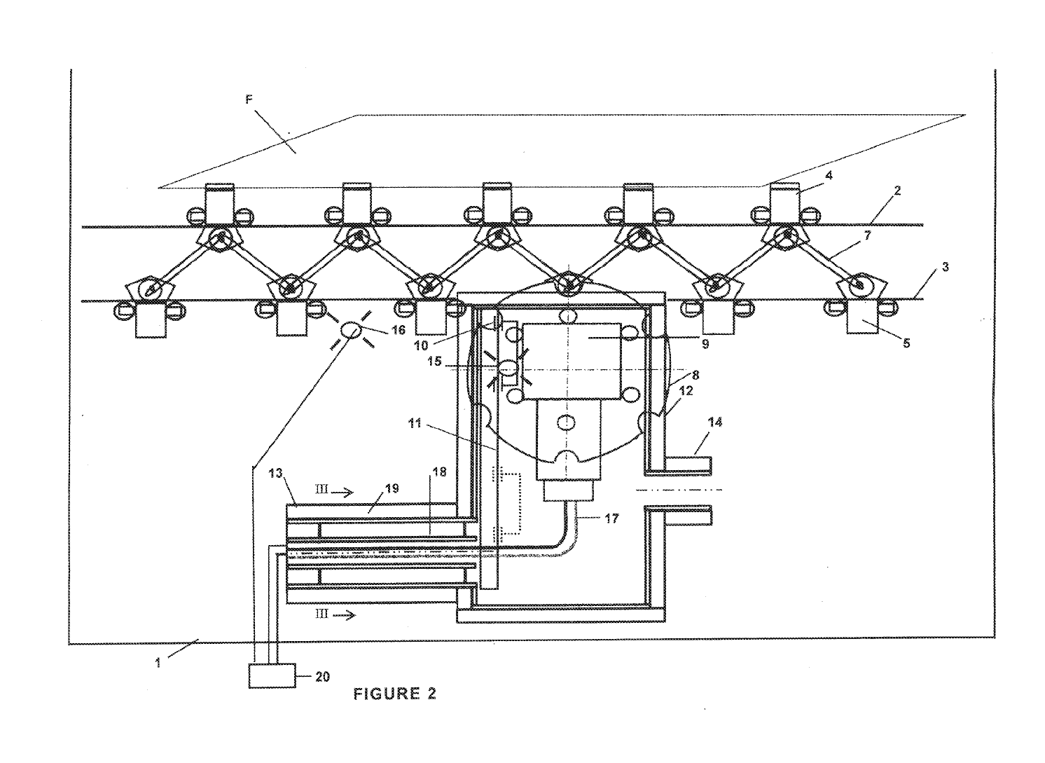

FIG. 2 is a plan view of the portion of the drawing machine comprising a pair of internal toothed wheels;

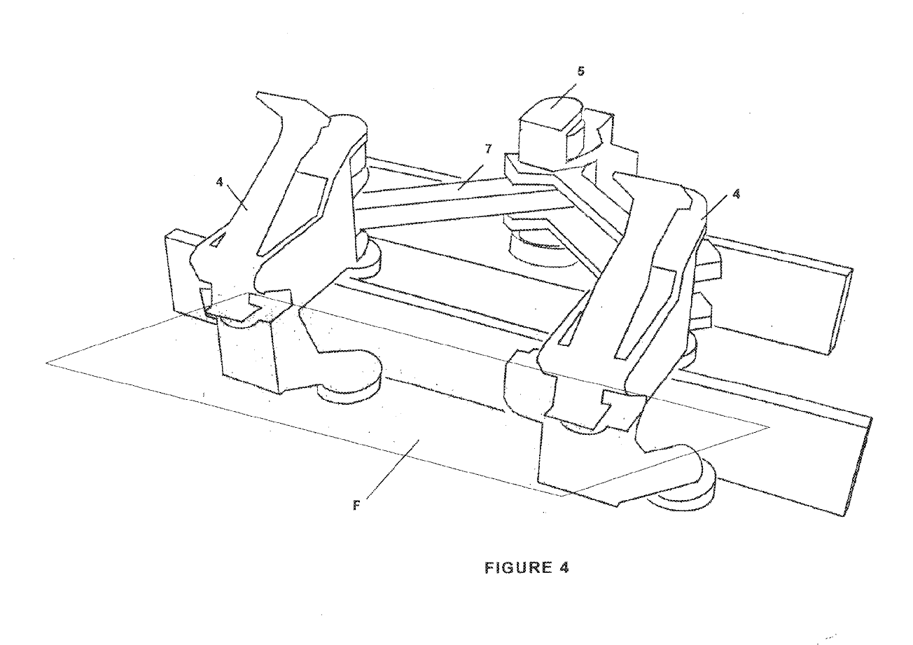

FIG. 3 is a sectional view along the line III-III in FIG. 2; and

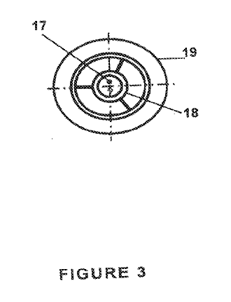

FIG. 4 is a perspective view of a portion of a chain of a machine according to the invention.

The film-drawing machine according to the invention comprises a temperature-controlled furnace 1, through which strands of two identical tracks pass. Each track comprises a first inner rail 2 and a second outer rail 3, which rails are parallel along a strand, then diverge. The rails 2 and 3 are endless. A plurality of clamps 4 move on the first rail 2, which clamps close at a point for adjusting the pitch below a fixed ramp for closing the clamps. The film F to be drawn is held on the two opposite edges by the clamps 4, which may be of the kind described in the French patent 2 686 041. Carriages 5 move on the second rail 3. The carriages 5, which are in a chain driven by four toothed wheels 6 outside the furnace 1, are articulated to the clamps 4. Two consecutive clamps 4 are articulated to the same carriage 5 by two links 7, so as to adjust the pitch of the clamps 4, that is to say the mutual distance of said clamps, when the angle between the two links 7 is modified. The carriages 5 roll against the outer rail 3 by means of a vertical bearing roller.

In addition to the four toothed wheels 6 for driving each chain outside the furnace 1, there are six toothed wheels 8 for driving each chain inside the furnace.

FIG. 2 shows one of said toothed wheels 8 driven by its own gear motor 9 and translationally mounted by means of shoes 10 on a rail 11, so as to be able to pass from a retracted position (shown by the dashed line), in which it does not mesh with the chain, to a drive position, in which said wheel 8 meshes with the chain. The gear motor 9 is arranged inside a casing 12. The casing 12 is inside the furnace 1. Said casing is cooled by the cooling air entering through an inlet 13 and leaving again through an outlet 14.

Each toothed wheel 8 is linked to its own detector 15, which detects the tooth pitch thereof. Each toothed wheel 8 is linked to a sensor 16, which detects the pitch of the clamps 4 at the point where the toothed wheel 8 meshes with the chain or near to said point, preferably immediately upstream in the direction of movement of the chain.

The two power supply wires 17 for the gear motor 9 leave the casing 12 through the outlet 13, which wires are surrounded by a sleeve 18, which is itself surrounded at a distance by an insulating sheath 19, the cooling air penetrating inside the casing 12 in the space between the sleeve 18 and the sheath 19.

A control unit 20 is located outside the furnace 1, which control unit receives information from the detectors 15 of each of the toothed wheels 8 and from the sensors 16 linked to each toothed wheel 8, and which control unit controls the devices 11 for moving the toothed wheels 8 in order to cause said wheels to mesh with the chain, after the matching of the tooth pitch of the toothed wheel 8 to the clamp pitch at the point on the chain where the wheel 8 is intended to mesh has been monitored and after the speeds of the wheel 8 and the chain have been synchronised.

If there is matching, the speed of rotation of the wheels 8 is synchronised at low speed with the movement speed of the chain, the wheels 8 are placed in the drive position, in which said wheels mesh with the chain, then all speeds are increased synchronously.

If there is no matching, the toothed wheels 8 are changed and the steps above are repeated.

1. Film-drawing machine, comprising a furnace,
through which one strand of an endless chain of clamps passes, which chain is driven by at least one toothed wheel, wherein at least one toothed wheel:
is inside the furnace,
is rotated by its own gear motor surrounded by a casing, placed in the furnace and cooled by cooling means, and
is mounted on its own movement device, so as to pass from a retracted position, in which it does not mesh with the chain, to a drive position, in which it meshes with the chain.

2. Machine according to claim 1, wherein the movement device is a device for translating in a direction perpendicular to the chain.

3. Machine according to claim 1, wherein each toothed wheel comprises its own detector which detects the tooth pitch of the toothed wheel.

4. Machine according to claim 1, wherein the chain comprises a sensor which is specific to each toothed wheel and detects the pitches of the clamps at the point on the chain where the toothed wheel is intended to mesh with the chain.

5. Machine according to claim 3, wherein a central control unit of the machine is connected to the sensor and to the detector and, when the pitches detected by said sensor and said detector match, controls the movement device in order to place the toothed wheel into the drive position.

6. Machine according to claim 1, wherein the power supply wires for the gear motor leave the casing through the inlet, in the casing, for the cooling air from the cooling means.

7. Machine according to claim 6, wherein, in the inlet, the wires are surrounded by a shared sleeve, which is itself surrounded at a distance by a thermally insulating sheath.

8. Method for starting a film-drawing machine according to claim 1, wherein, while the wheels are retracted, the matching of the tooth pitch of each wheel with the clamp pitch at the point where each wheel is intended to mesh with the chain is monitored and, if there is matching, the speed of rotation of the wheels is synchronised at low speed with the movement speed of the chain, then the wheels are placed in the drive position and all speeds are increased synchronously.
